(19) United States
(12) Patent Application Publication
(10) Pub. No.: US 2007/0274160 A1
(43) Pub. Date: Nov. 29, 2007

(54) DEVICE FOR DISPLAYING DIGITAL OR ALPHANUMERIC SYMBOLS

(75) Inventors: Christoph Behling, London (GB); Thomas Houlon, Boudry (CH)

Correspondence Address: PEARNE & GORDON LLP, 1801 EAST 9TH STREET, SUITE 1200, CLEVELAND, OH, 44114-3108, US

(73) Assignee: TAG HEUER SA, La Chaux-de-Fonds (CH)

(21) Appl. No.: 11/752,672

(22) Filed: May 23, 2007

Related U.S. Application Data
(63) Continuation of application No. PCT/EP06/63420, filed on Jun. 21, 2006.

(30) Foreign Application Priority Data
Jun. 23, 2005 (CH) 2005CH-1065

(51) Int. Cl. G04B 47/00

(52) U.S. Cl. 368/10

(57) ABSTRACT

Electronic watch with a segment display with LEDs, wherein precious stones or synthetic stones or gemstones made of glass are arranged in front of the display segments so as to display digital or alphanumeric symbols by lighting up stones by means of the corresponding light sources.

### RELATED APPLICATIONS

The present application is a continuation of international application PCT/EP2006/063420 (WO06/136587), the content of which is included by reference, and which claims priority of Swiss patent application 2005CH-1065 of Jun. 23, 2005, the contents whereof are included by reference.

### TECHNICAL FIELD

The present invention concerns a device for displaying digital or alphanumeric symbols, for example a watch. The present invention concerns in particular a device for displaying symbols by segments.

### STATE OF THE ART

Devices displaying the time or other indications by means of digital or alphanumeric symbols constituted by segments are known. Different technologies can be used to this effect. Liquid Crystal Displays are widespread and have the advantage of a very reduced electric consumption. However, as liquid crystals do not emit their own light, these devices require an additional light source for them to be consultable during the night or in low ambient light. Even during the day, the contrast provided by an LCD is low.

Segment displays that emit their own light are also known. Light emitting diode (LED) displays or plasma displays are for example known that have the advantage of being very readable even in low light. These devices however have the disadvantage of a high electric consumption that limits their use in portable devices such as watches, calculators or portable telephones. LED display watches therefore generally comprise an organ allowing the display segments to be activated during a predetermined duration, before the display switches itself off in order to spare the battery.

The aspect of switched-off LEDs is however not very aesthetic. Furthermore, the upper surface of LEDs is fragile, so that they must be protected by a glass. This glass increases the thickness of the device and reflects external light, which impairs the readability of the display. Finally, LED displays have often been used for economical watches, so that their image is frequently, though wrongly, associated with a lower quality.

FR2838838 describes a wristwatch indicating the hours and the minutes by means of two series of LEDs representing the hours, respectively the minutes. Reading the time is impractical since it does not resort to digital or alpha-numeric symbols but to an unusual code. This solution is at most suited for displaying hours from 1 to 12 and minutes by 5-minute intervals, but would be impracticable for displaying exact minutes, since a row of 60 diodes would be necessary. This document also suggests associating a translucent stone to each light source, but does not indicate how the stones are placed relatively to the LEDs and does not propose in particular to light the stones.

U.S. Pat. No. 6,553,786 describes a jewel comprising a diamond pattern, including fluorescent diamonds placed so as to write out a text when the pattern is lit by ultraviolet light. This construction only allows fixed texts or symbols to be displayed, but is not adapted for displaying variable alpha-numeric data such as time indications.

EP894449 describes a watch wristlet provided with LEDs to create an animated decorative effect. The diodes are not covered and do not aim to display digital or alpha-numeric indications.

U.S. Pat. No. 4,601,584 describes a watch dial provided with LEDs for displaying different amusing designs. The LEDs are however not used for displaying digital or alpha-numeric symbols and are also not protected by stones.

GB2276071 describes a jewel comprising stones that are back-lit by means of LEDs. The LEDs are however not used for displaying digital or alpha-numeric symbols.

### BRIEF SUMMARY OF THE INVENTION

One aim of the present invention is thus to propose a device, notably a watch, that avoids these disadvantages of the prior art.

According to the invention, these aims are achieved by means of a device having the characteristics of the independent claim.

The use of stones, for example natural or synthetic precious stones, or gemstones made of glass, mounted in front of light sources allow on the one hand the device's aesthetic to be improved, notably when the display is switched off, and on the other hand to protect each of the light sources from shocks and scratches, without requiring a glass.

Furthermore, the illuminating of the stones transparently, by means of light emitting sources activated selectively, allows them to scintillate or sparkle, notably when the stones are cut with facets.

### BRIEF DESCRIPTION OF THE DRAWINGS

Examples of embodiments of the invention are indicated in the description illustrated by the attached figures in which:

FIG. 1 illustrates a view from above of a watch embodiment according to a first embodiment of the invention.

FIG. 2 shows a perspective view of a watch case, without the bottom, according to a first embodiment of the invention.

FIG. 3 illustrates a view from above of a watch case according to a second embodiment of the invention.

FIG. 4 illustrates a partial cross sectional view along the cross-section plane A-A of FIG. 3 of a watch case according to the invention.

### EXAMPLES OF EMBODIMENT(S) OF THE INVENTION

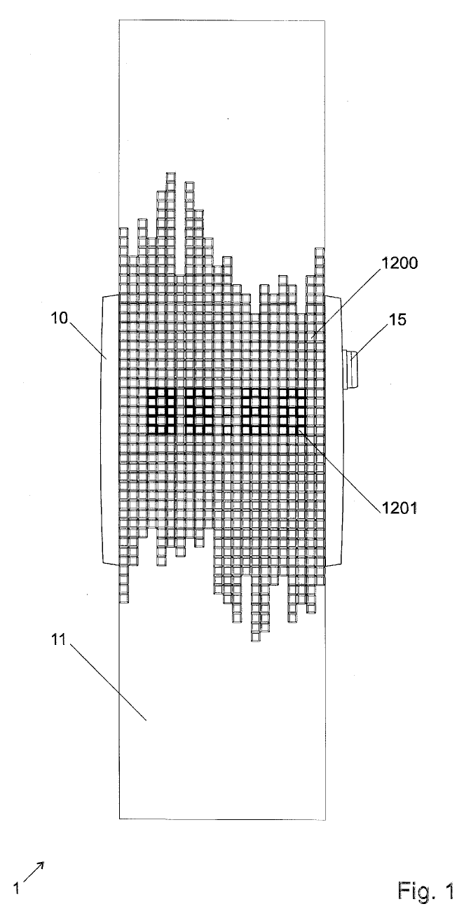

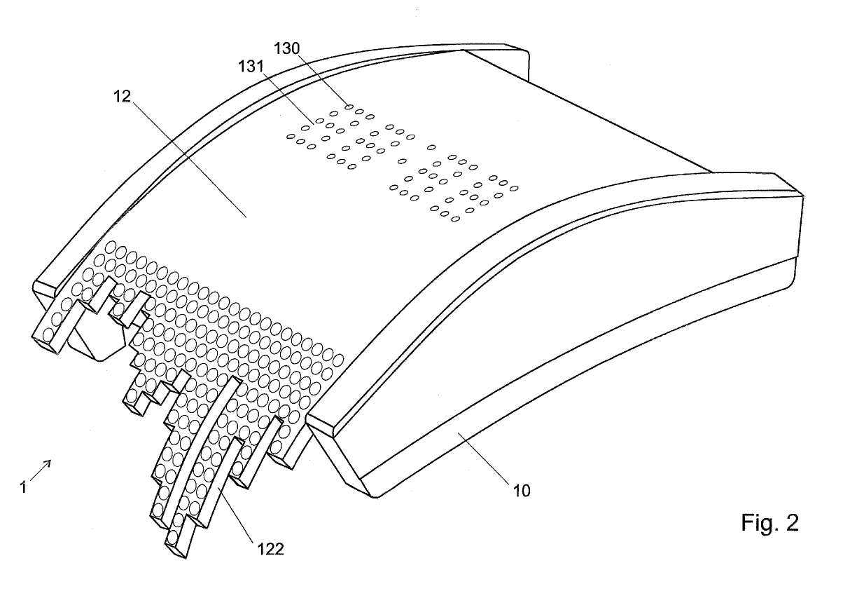

FIGS. 1 to 4 illustrate an embodiment of an inventive device, constituted in this example by a wristwatch. The watch includes a case 10 whose upper face is constituted by a plate, or dial, 12 entirely covered with transparent or translucent stones 120. In a preferred embodiment, the plate 12 is an integral part of the watch case.

In this document, stone is to be understood as any solid element, transparent or translucent, that diffract incident light and/or light coming through the stone along different directions, so as to create scintillating, iridescent, shimmering etc. effects. Stone is to be understood notably as:
Natural precious stones, for example diamonds,
Synthetic or artificial precious stones, for example artificial diamonds,
Solid elements of glass, crystal or synthetic, mineral or organic material, cut or moulded, with or without facets, so as to scintillate and to project light reflects that vary according to the orientation of the internal and external incident light, including glass or amber,
Solid transparent or translucent elements incorporating inclusions of mother-of-pearl or other synthetic, mineral or organic particles, in order to diffract the light crossing the solid body in different directions, the inclusions being translucent or opaque,
Any other transparent or translucent element of noble, precious or iridescent aspect and usually used in the field of jewellery and bijouterie.

The stones are placed in a matrix, in a pattern comprising several lines and several columns. In this example, the lines and columns are equidistant. Other arrangements of stones, for example stones that cover only a limited portion of the upper face of the case, or several disjointed portions or even irregular arrangements, for example stones of unequal size that are snow-set, can also be conceived within the frame of this invention. Furthermore, it is possible to use stones of different type or colour, or stones cut differently from one another.

In the illustrated embodiment, the number of stones of the columns is different; the columns thus have variable lengths. The watch case 10 is entirely covered with stones, and other stones seem to overflow from the case to cover a portion of the wristlet 11. The limit between the stones above the case and those that overhang the wristlet is not clearly discernible. The wristlet is preferably a flexible wristlet of leather, rubber, textile or synthetic material covered for example of satin or of textile.

Certain stones, indicated by the reference 1201, are placed in front of the light sources, for example LEDs 121. The reference 1200 indicates the other stones that are not back-lit. The reference 120 indicates indifferently the back-lit stones 1201 and the non back-lit stones 1200.

The light emitted by the selected LEDs 121 goes through the corresponding transparent or translucent stones 1201 and is reflected in different directions by the different facets on the upper face of the stones, so as to create a scintillating lighting.

An electronic circuit, not represented, for example a horological microcontroller or a segment display controller, determines the LEDs that are selected at each instant so as to display the digital or alphanumeric symbols desired. The electronic circuit is powered by en autonomous electric source, not represented, for example a battery or a photovoltaic cell.

In the illustrated example, the LEDs are arranged so as to constitute segments of digital symbols. Four digits can be displayed to indicate a time from 00 to 12 (or from 00 to 23) and a minute from 00 to 59. Two points can furthermore be displayed to separate the two hour-digits from the two minute-digits. In one embodiment, these two points can blink with a frequency of one second. Other types of symbols can of course be provided for displaying other indications, for example seconds, the date, chronograph indications, a second time zone, etc. The control organ 15, or another organ such as a push-button or crown, can be used for selecting the displayed indications.

The back-lit stones 1201 in this embodiment have a more or less square shape, different from the elongated shape of the usual display segments with 7 segments per symbol. In the illustrated embodiment, the digital symbols are constituted by selected the diodes that are lit in a group of 13 diodes per symbol. Preferably, certain adjacent LEDs are connected electrically and are thus always selected or unselected simultaneously by means of a single control signal. The number of control signals necessary for displaying one of the ten numbers 0 to 9 is thus limited. In this case, a display segment is thus constituted by several adjacent light sources in the horizontal or vertical direction.

The illustrated watch further comprises at least one control organ 15, for example a crown or a push-button, in order to control the different functions of the watch and adjust the displayed time. The LEDs corresponding to the displayed indication are preferably only lit up when the user operates the control organ 15, then automatically switched off after a predetermined period in order to save the watch's battery or autonomous source of electric current.

In one embodiment, the light intensity produced by the selected LEDs is variable and depends for example on the user's adjustments, on the ambient light determined by a photovoltaic cell, on the state of the battery or on the time of day for example. It is thus possible to vary the display contrast or the stones' scintillating according to the user's tastes or to ambient conditions. Furthermore, it is also possible to light up all the light sources 121 simultaneously, as well as other optional additional light sources, in order to have the stones 120 scintillate independently of the displayed indication. Furthermore, the light intensity emitted by the different light sources can be modulated, in time and in space, in order to generate variable iridescent reflections.

The stones 120 are fastened on the plate 12 defining the upper face of the case 10 by setting or gluing. In the case of gluing, each stone can be glued independently in an opening 130, in a blind hole or directly onto the upper surface of the plate 12. In one embodiment, it is also possible to glue several stones in a single operation by means of an adhesive film, for example a transfer or self-adhesive film deposited on the case's upper face 12.

In order to prevent any risk of the stones coming unglued or unset, it is important that they be mounted on a rigid surface, for example a sufficiently thick metallic plate 12. Furthermore, all the stones, including those that cover a portion of the wristlet 11, are preferably mounted on the same plate 12 or at least on several elements united with one another and jointly forming a non-deformable surface. To this effect, in the embodiment illustrated in FIG. 12, the upper face of the watch is constituted by a metallic plate 12 comprising a protruding portion 122 that partially covers one end of the bracelet (not illustrated). The protruding portion 122 is cut so as to correspond to the length of the columns of stones; the portion 122 is entirely covered by the stones and is thus practically invisible when the stones are mounted. In this example, the protruding portion comprises openings at the places provided for each stone. According to the chosen method of assembly, such openings, or blind holes, could be provided on the whole of the plate 12.

The plate 12 could of course also cover part of the wristlet's second end.

In a variant embodiment, not represented, the stones covering the wristlet could be mounted on an adapter or on another rigid element connected to the wristlet and held united with the case 10, for example by means of screws, pins or rods, so as to constitute with the supper face of the case 10 a single rigid surface without discontinuities.

The gluing or setting of all the stones on a non-deformable single surface makes it possible to ensure perfectly regular interstices between the stones of the pattern, and reduces the risk of them coming unset or unglued.

Use of stones mounted on a single rigid surface 12 astride the case 10 and the wristlet is also possible with watches having hands, or watches with digital display on a portion without any stones. This characteristic is thus independent of the back-lit diodes.

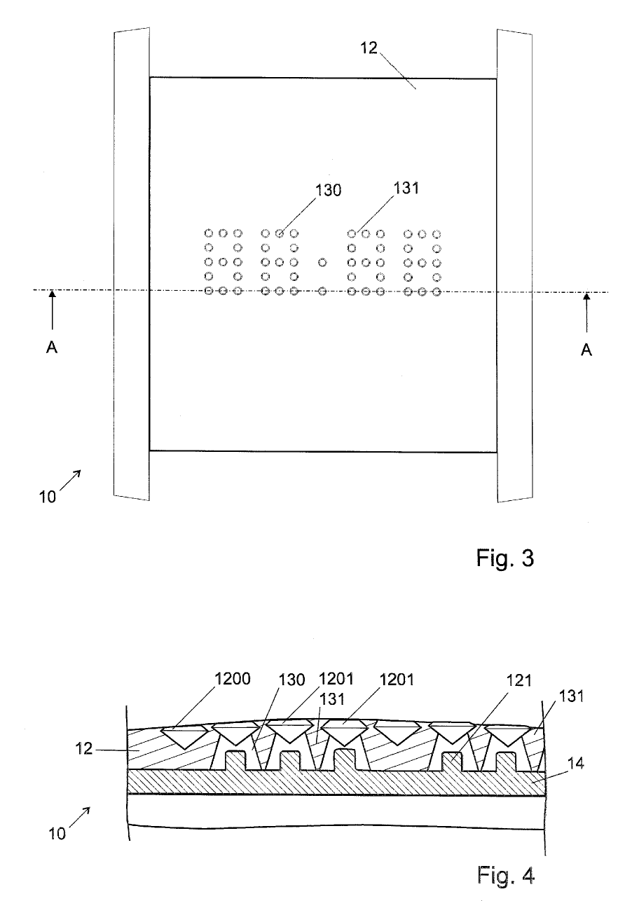

FIG. 3 illustrates a view from above of a variant embodiment of a watch case 10 whose upper face 12 does not cover the wristlet. This face is provided with openings 130 at the places provided for the LEDs. The stones 120 are designed to be mounted above each opening 130 and in a matrix between and around the openings. In a preferred embodiment, the stones thus mounted constitute the upper surface of the watch, which thus does not have a dial and is not covered with a glass. It is however also possible to mount the stones only on a portion of the upper face.

FIG. 4 illustrates a partial cross sectional view along the cross-section plane A-A of FIG. 3 of a watch case 10 with several stones 120 mounted. The case includes a metallic plate 12 with the mentioned openings 130. The stones are mounted by setting or gluing in the openings and around these openings. A printed circuit board (PCB) 14 or other connecting means, is mounted under the plate 12 and carries a certain number of LEDs 121, for example red diodes and/or blue diodes, represented diagrammatically. The printed circuit comprises conducting paths or through-holes for conducting leads, so as to connect the different LEDs to the watch's electronic circuit (not represented).

The plate 12 is preferably placed directly onto the printed circuit 14. In this manner, the portions of the plate between the openings 130 constitute curtains 131 that prevent the light emitted for one LED 121 to reach a neighbouring stone.

In the illustrated example, the axis of the LEDs 121 is perpendicular to the plane of the plate 12. It is however also possible to mount at least certain diodes parallel to the facets of the stones 12 or to provide several diodes under certain stones, so as to make them scintillate more or differently.

A joint, not represented in the figures, is preferably provided around each stone, or in each opening 130, so as to prevent infiltrations of water until the printed circuit 14. If the stones 1200 that are not back-lit are mounted in a blind hole, as in FIG. 4, it is possible to associate an individual joint only with each back-lit stone 1201, where the risks of water infiltrations through the openings 130 can occur.

In a variant embodiment, the tightness is ensured by a circular elastic joint compressed around each stone. It is also possible to use a glue joint, made of a material hardening in air, in light, in ultraviolet light, etc. and that allows each stone to be glued in the opening 130 and at the same time to ensure its tightness. To this effect, a ringed groove, not represented, is preferably worked or arranged in the plate 12, inside each opening 130, to lodge there the whole periphery of the stone 1201; this groove is filled with glue during assembly, for example by means of a syringe, in order to ensure optimal holding of the stone. The glue joint preferably maintains a certain suppleness after hardening so as to ensure that the stone is held even in the case of dilatations or deformations. Setting, for example by deformation of portions of the plate 12, can also be performed additionally to gluing.

In another variant embodiment, the openings 130 are filled with glue or with another synthetic material before, during or after mounting of the stones 120. It would also be possible to ensure tightness by means of an additional layer between the plate 12 and the printed circuit 14, for example a transparent synthetic plate or a tight plate in which holes are drilled for each diode. In this case, a single element prevents the infiltration of water coming from different stones. Finally, the tightness could also be ensured under the plate 14, which itself would be protected only imperfectly.

In another embodiment, the tightness is ensured by means of a compressible and electrically conducting elastic mat between the LEDs and the remainder of the circuit. The mat is for example constituted of electrically insulating siliconed rubber with a width of 0.3 to 1 mm for example. Metallic wires or threads, preferably of gold, are integrated in the mat which they traverse perpendicularly to the mat's plane, with a space between them of about 0.05 to 1 mm. The wires are all cut flush with the upper surface and lower surface of the mat. An electric contact is established through the wires between each pin of the LEDS resting on the upper side of the mat and corresponding contact points under the lower surface of the mat, for example on a PCB resting under the mat. The rubber between the wires ensures on the one hand the electric insulation between the different points of electric contact and on the other hand the tightness, any humidity in this case reaching the LEDs being blocked by the mat. Such mats are available for example from the company SHIN-ETSU.

1. Electronic device comprising:
a display constituted of light sources;
an electronic circuit for controlling said light sources;
an autonomous electric current source for powering said electronic circuit,
a plurality of transparent or translucent stones in front of said light sources,
wherein digital or alphanumeric symbols are displayed by selectively lighting up said stones by means of said lit light sources.

2. The device of claim 1, wherein said stones are arranged along a plurality of adjacent columns and adjacent lines, said light sources being placed behind certain of said stones, said lines or columns comprising stones that are not associated with light sources and that cannot be individually back-lit.

3. The device of claim 2, wherein certain lines and/or certain columns have unequal length.

4. The device of claim 2, wherein said columns are all equidistant and wherein said lines are all equidistant.

5. The device of claim 1, constituted by a watch, said stones covering at least a substantial portion of the upper side of the case of said watch.

6. The device of claim 5, with stones further covering at least a portion of the wristlet immediately adjacent to said case.

7. The device of claim 6, wherein said stones are placed without discontinuity between said upper face of the watch case and said wristlet.

8. The device of claim 1, further comprising tightness means for preventing water infiltrating around said stones from reaching said electronic circuit.

9. The device of claim 8, said tightness means comprising an individual compressible joint associated individually to at least certain of said stones.

10. The device of claim 8, said tightness means comprising a hardening material, for example a glue, both preventing the water from infiltrating around at least certain of said stones and allowing them to be held.

11. The device of claim 10, said stones being mounted on a plate in which openings are drilled for accommodating at least certain of said stones, said hardening material being placed in ring grooves machined in a plate inside each said opening.

12. The device of claim 8, comprising a tight element between said stones and said electronic circuit in order to prevent water infiltrations coming from different stones.

13. The device of claim 1, said stones being set individually.

14. The device of claim 1, several stones being glued individually.

15. The device of claim 1, several stones being glued in a single operation, for example by means of a transfer film or a self-adhesive film.

16. The device of claim 1, all said stones being mounted onto a single plate or on several elements forming a non deformable surface.

17. The device of claim 1, said light sources being constituted by LEDs, the device comprising an organ that can be actuated by the user to light the selected LEDs during a determined duration.

18. The device of claim 1, wherein said light sources are organized in segments that can be selected individually for displaying said digital or alphanumeric symbols.

19. The device of claim 18, wherein at least certain of said segments are constituted by several adjacent light sources that can be selected only simultaneously.

20. The device of claim 19, allowing several digital symbols corresponding to hour and minute indications to be displayed, each symbol being displayed by means of at least 7 segments of which at least some are constituted of n adjacent light sources selected simultaneously.

21. The device of claim 1, the light intensity produced by said light sources depending on at least one of the following factors:
level of ambient light;
level of battery;
adjustment by the user.

22. The device of claim 1, said light sources being separated from their neighbours by curtains so as to allow one stone to be lit without its neighbours being lit.

23. The device of claim 22, said light sources being mounted on a connection plate,
a perforated plate being superimposed over said connection plate, an opening being provided above each light source,
said stones being mounted on the face of said perforated plate opposite said light sources.

24. The device of claim 23, being constituted by a watch, said perforated plate defining the upper face of the watch case and protruding from at least one side of the case so as to cover a portion of the wristlet.

25. Electronic watch comprising:
light sources;
transparent or translucent elements in front of said light sources;
an electronic circuit for controlling said light sources,
an autonomous electric current source for powering said electronic circuit,
wherein the light sources are arranged and controlled so as to display numeric or alphanumeric symbols by selection of the lit light sources.

26. Electronic watch comprising:
light sources;
one transparent or translucent element in front of each light source;
an electronic circuit for controlling said light sources,
an autonomous electric current source for powering said electronic circuit,
wherein the light sources are arranged and controlled so as to display numeric or alphanumeric symbols by selection of the lit light sources.

27. The electronic watch of claim 26, further comprising additional transparent or translucent elements, said additional elements not being in front of light sources.

28. Electronic watch comprising:
a front surface;
a plurality of light sources;
one transparent or translucent element in front of each light source, said elements being flush with said front surface;
an electronic circuit for controlling said light sources,
an autonomous electric current source for powering said electronic circuit,
wherein the light sources are arranged and controlled so as to display the current time with numeric symbols, by selection of the lit light sources.

29. The watch of claim 28, further comprising curtains preventing the light emitted by one light source to reach a neighbouring transparent or translucent element.
